(19) United States
(12) Patent Application Publication
(10) Pub. No.: US 2015/0178951 A1
(43) Pub. Date: Jun. 25, 2015

(54) IMAGE PROCESSING SYSTEM AND METHOD

(71) Applicant: PANAMORPH, INC., Colorado Springs, CO (US)

(72) Inventor: Shawn L. KELLY, Colorado Springs, CO (US)

(21) Appl. No.: 14/580,219

(22) Filed: Dec. 23, 2014

Related U.S. Application Data
(60) Provisional application No. 61/920,408, filed on Dec. 23, 2013.

(51) Int. Cl. G06T 9/00; H04N 19/44; H04N 19/85

(52) U.S. Cl. CPC G06T 9/00; H04N 19/85; H04N 19/44

(57) ABSTRACT

For each of a plurality of pairs of correlated first and second image data components of a digitized image, a first encoded value is proportional to a first difference between the first image data component and a first product of the second image data component multiplied by a first factor, and a second encoded value is proportional to a second difference between the second image data component and a second product of the first image data component multiplied by the first factor. A corresponding encoded digitized image is formed from a plurality of pairs of first and second encoded values corresponding to the plurality of pairs of correlated first and second image data components. The encoded digitized image is decoded by a corresponding decoding process that provides for inverting the steps of the associated encoding process, so as to provide for recovering the original image data components with substantial accuracy.

### CROSS-REFERENCE TO RELATED APPLICATIONS

The instant application claims the benefit of prior U.S. Provisional Application Ser. No. 61/920,408 filed on 23 Dec. 2013, which is incorporated by reference herein in its entirety.

### BRIEF DESCRIPTION OF THE DRAWINGS

FIG. 1 illustrates an image processing system incorporating image encoding and image decoding processes;

FIG. 2 illustrates an example of a portion of a color image comprising a 10×10 array of pixels;

FIG. 3 illustrates details of the image encoding process incorporated in the image processing systems illustrated in FIGS. 1 and 18;

FIG. 4 illustrates an example of a partitioning of the image illustrated in FIG. 2 in accordance with the image encoding process illustrated in FIG. 3; FIGS. 5a and 5b illustrate an example of an encoded image generated from the partitioned image illustrated in FIG. 4 in accordance with the image encoding process illustrated in FIG. 3;

FIG. 6 illustrates details of the image decoding process incorporated in the image processing systems illustrated in FIGS. 1 and 18; FIGS. 7a and 7b illustrate and example of a partitioned decoded image generated from the encoded image illustrated in FIGS. 5a and 5b in accordance with the image decoding process illustrated in FIG. 6;

FIG. 8 illustrates an example a numeric example of a 10×10 array of image data;

FIG. 9 illustrates an example the encoded image data generated from the image data of FIG. 8 in accordance with the image encoding process illustrated in FIG. 3;

FIG. 10 illustrates decoded image data decoded from the encoded image data of FIG. 9 in accordance with the image decoding process illustrated in FIG. 6;

FIG. 11 illustrates a plot of the image data illustrated in FIG. 8;

FIG. 12 illustrates a plot of the encoded image data illustrated in FIG. 9;

FIG. 13 illustrates an example of integer-truncated encoded image data generated from the image data of FIG. 8 otherwise in accordance with the image encoding process illustrated in FIG. 3;

FIG. 14 illustrates the integer-truncated decoded image data decoded from the integer-truncated encoded image data of FIG. 13 otherwise in accordance with the image decoding process illustrated in FIG. 6;

FIG. 15 illustrates the difference between the image data illustrated in FIG. 8 and the integer-truncated decoded image data illustrated in FIG. 14;

FIG. 16 illustrates an image pixel comprising image data partitioned into most-significant and least-significant data portions.

FIG. 17a illustrates an image pixel formed from the most-significant data portion of the pixel illustrated in FIG. 16;

FIG. 17b illustrates an image pixel formed from the least-significant data portion of the pixel illustrated in FIG. 16; and

FIG. 18 illustrates a second aspect of an image processing system incorporating image encoding and image decoding processes.

### DESCRIPTION OF EMBODIMENT(S)

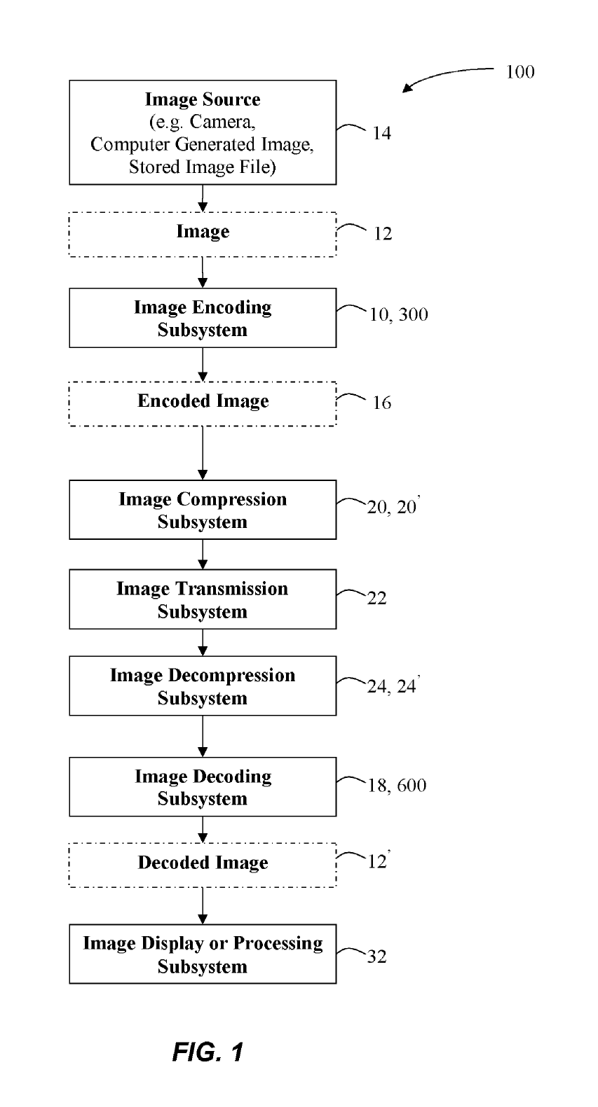

Referring to FIG. 1, in accordance with a first aspect, an image processing system 100 incorporates an image encoding subsystem 10 that encodes an image 12 from an image source 14 so as to generate a corresponding encoded image 16, so as to provide for mitigating against distortion when the image 12′ is later decoded by a corresponding image decoding subsystem 18 following a conventional compression, transmission and decompression of the encoded image 16 by respective image compression 20, image transmission 22 and image decompression 24 subsystems. Generally, relatively smoother and less varied image data is more efficiently compressed and decompressed with greater fidelity, than relatively less smooth and more varied image data. The image encoding subsystem 10 provides for reducing variability in the encoded image 16 relative to that of the corresponding unencoded image 12, whereby the value of each element of the encoded image 16 is generated responsive to a difference of values of corresponding elements of the unencoded image 12.

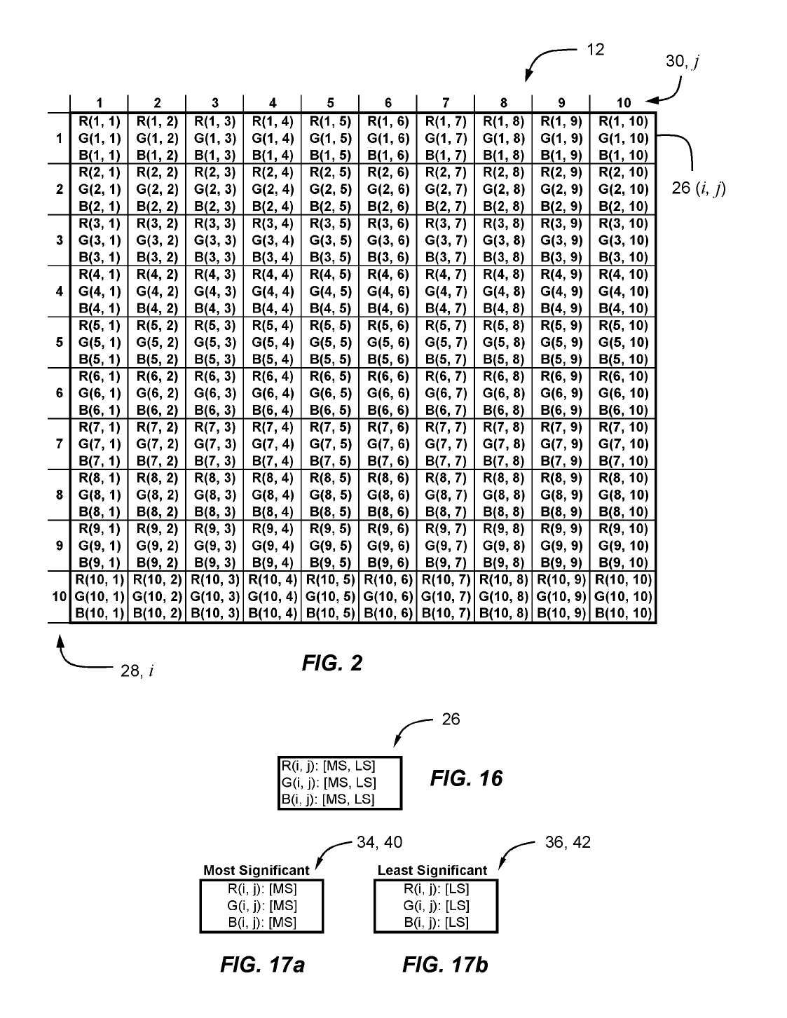

Referring also to FIG. 2, an example of color image 12, 12.1 is illustrated comprising a 10×10 array of 100 pixels 26 organized as ten rows 28—each identified by row index i—and ten columns 30—each identified by column index j. Each pixel 26(i, j) comprises a plurality of three color components R(i, j), G(i, j) and B(i, j) that represent the levels of the corresponding color of the pixel 26(i, j), i.e. red R(i, j), green G(i, j), and blue B(i, j) when either displayed on, or subsequently processed by, an associated image display or processing subsystem 32.

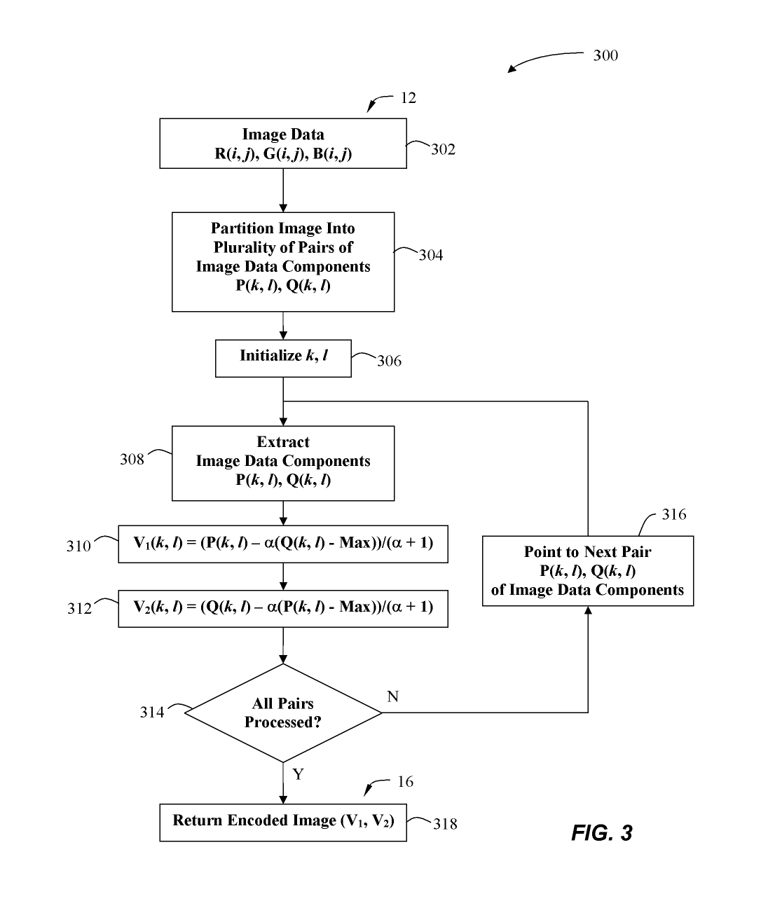

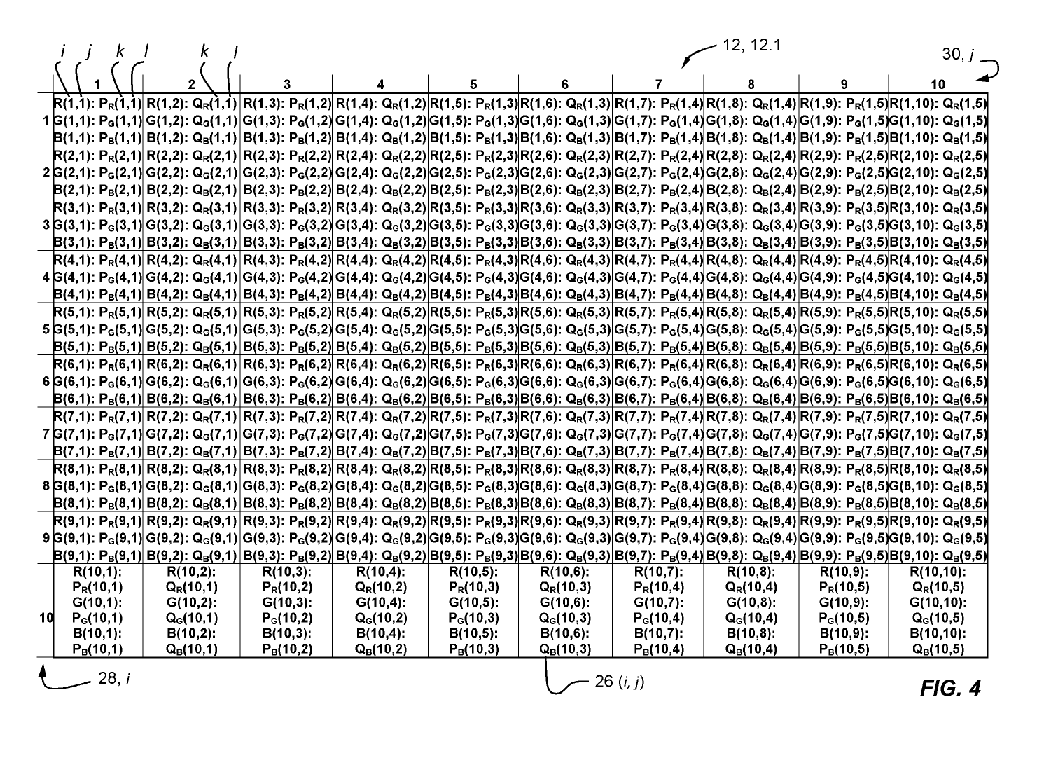

Referring to FIG. 3, an image encoding process 300 of the image encoding subsystem 10 begins in step (302) with input of the data of the image 12 to be encoded. For example, the color image 12, 12.1 illustrated in FIG. 2 comprises an array of pixels 26(i, j), each of which contains corresponding red R(i, j), green G(i, j), and blue B(i, j) image data components. For purposes of encoding, each image data component red R(i, j), green G(i, j), and blue B(i, j) at each separate pixel location (i, j) is a separate data element. The image encoding process 300 operates on pairs of neighboring data elements that are typically correlated with one another to at least some degree. For example, neighboring color components—i.e. R(i, j) and R(i+m, j+n), G(i, j) and G(i+m, j+n), or B(i, j) and B(i+m, j+n), wherein m and n have values of −1, 0 or 1, but not both 0—typically would have some correlation with one another. Alternatively, different color components of the same pixel, i.e. R(i, j) and G(i, j), G(i, j) and B(i, j), or R(i, j) and B(i, j) might be paired with one another. Accordingly, in step (304), the image 12 to be encoded is partitioned into a plurality of pairs of image data components P(k, 1) and Q(k, 1), for example, as described hereinabove, wherein there is a one-to-one correspondence between image data components P(k, 1) and Q(k, 1) and image data components R(i, j), G(i, j), and B(i, j). Accordingly, each image data component R(i, j), G(i, j), and B(i, j) is accounted for only once in one—and only one—of either image data component P(k, l) or image data component Q(k, l), so that the resulting total number of pairs of image data components P(k, l) and Q(k, l) will be half of the total number of pixels 26(i, j) in the original image 12 to be encoded, with all image data components R(i, j), G(i, j), and B(i, j) from every pixel 26(i, j) accounted for. For example, referring to FIG. 4, in one embodiment, each image data component R(i, j), G(i, j), and B(i, j) of the original image 12 is processed independently of the other and for a given color, the image data components P(k, l) and Q(k, l) are related to the original corresponding image data component X(i,j), where X =R, G or B, as follows:

for P_{X}(k, l), i=k and j=2·l−1, and (1a)

for Q_{X}(k, l), i=k and j=2·l. (1b)

Accordingly, for the embodiment illustrated in FIG. 4, for each color component R, G, B, for each row i of the image 12, alternate adjacent columns are associated with the corresponding image data components P(k, l) and Q(k, l), for each pair to be encoded. Furthermore, given the relationships of equations (1a) and (1b), steps (304) through (316) would be repeated for each color component R, G, B for this embodiment.

Following step (304), in step (306), the indices k, l that point to the pair of image data components P(k, l) and Q(k, l) are initialized, for example, to values of 0, after which, in step (308), the corresponding pair of image data components P(k, l) and Q(k, l) is extracted from the original image 12. Then, in steps (310) and (312), corresponding encoded data values V₁(k, l) and V₂(k, l) are calculated as follows, responsive to a linear combination of the pair of image data components P(k, l) and Q(k, l), wherein each linear combination is responsive to a generalized difference therebetween, and the different linear combinations are linearly independent of one another, for example:

V₁=[P−α·(Q−Max)]/(α+1)=f(P, Q); and (2a)

V₂=[Q−α·(P−Max)]/(α+1)=f(Q, P), (2b)

wherein a is a constant; and offset value Max is the maximum value P or Q could achieve, and the resulting values of V₁ and V₂ range from 0 to Max. For example, for 8 bit image data components, Max=255. Alternatively, the P and Q values could have different upper bounds, for example, if corresponding to different type of data, e.g. different colors, in which case different values of Max could be used for the P and Q values in equations (2a) and (2b). However, in most cases, such as for pixel intensity, color, etc. the two values P and Q typically share the same maximum values.

Then, in step (314), if all pairs of image data components P(k, l) and Q(k, l) have not been processed, then in step (316) the indices (k, l) are updated to point to the next pair of image data components P(k, l) and Q(k, l). Otherwise, from step (314), the encoded image 16 is returned in step (318).

For example, FIGS. 5a and 5b illustrate the encoded image 16 resulting from the original image 12, showing the relationship between the encoded data values V₁(k, l) and V₂(k, l) and the corresponding pairs of image data components P(k, l) and Q(k, l) from the original image 12 illustrated in FIG. 4, wherein the pairs of encoded data values V₁(k, l) and V₂(k, l) are illustrated as replacing the corresponding pairs of image data components P(k, l) and Q(k, 1) in the encoded image 16, with the correspondence between the row index i and column index j and the associated values of indices k, l given by equation (1a) for the first encoded data values V₁(k, l), and by equation (1b) for the second encoded data values V₂(k, l).

Returning to FIG. 1, after the image data 12 is encoded by the image encoding process 300 illustrated in FIG. 3, the resulting encoded image 16 is compressed using a conventional image compression process 20′, and then transmitted to a separate location, for example, either wirelessly, by a conductive or optical transmission line, for example, cable or DSL, by DVD or BLU-RAY DISC™, or streamed over the internet, after which the compressed, encoded image data is then decompressed by a conventional image decompression process 24′, and then input to the image decoding subsystem 18 that operates in counterpart to the above-described image encoding process 300.

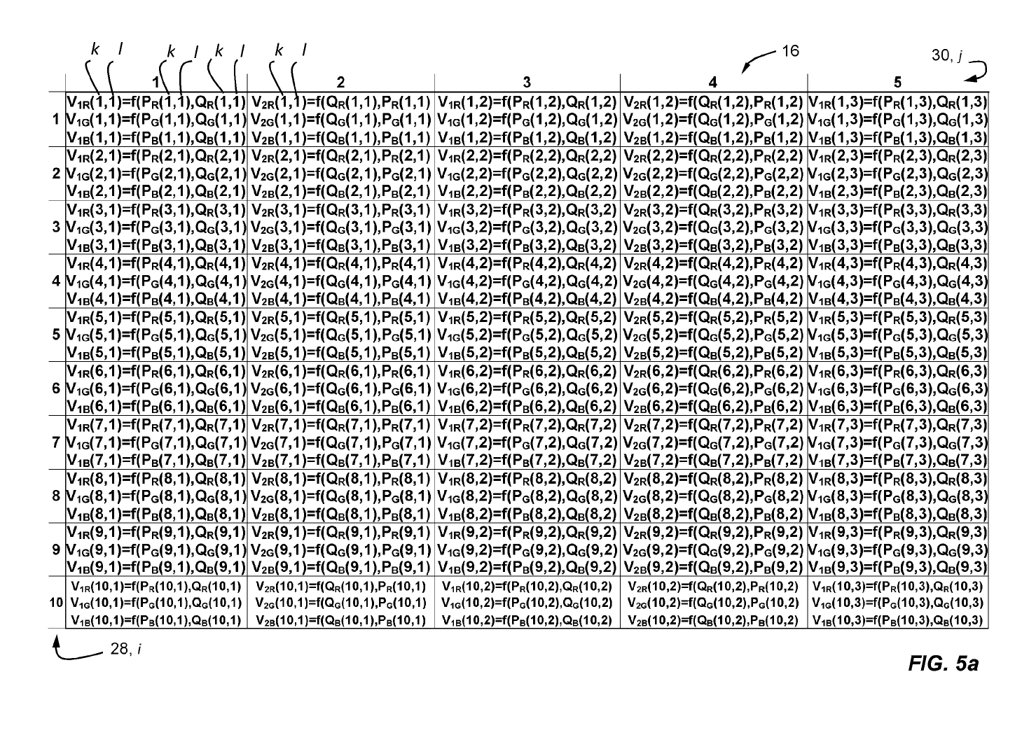

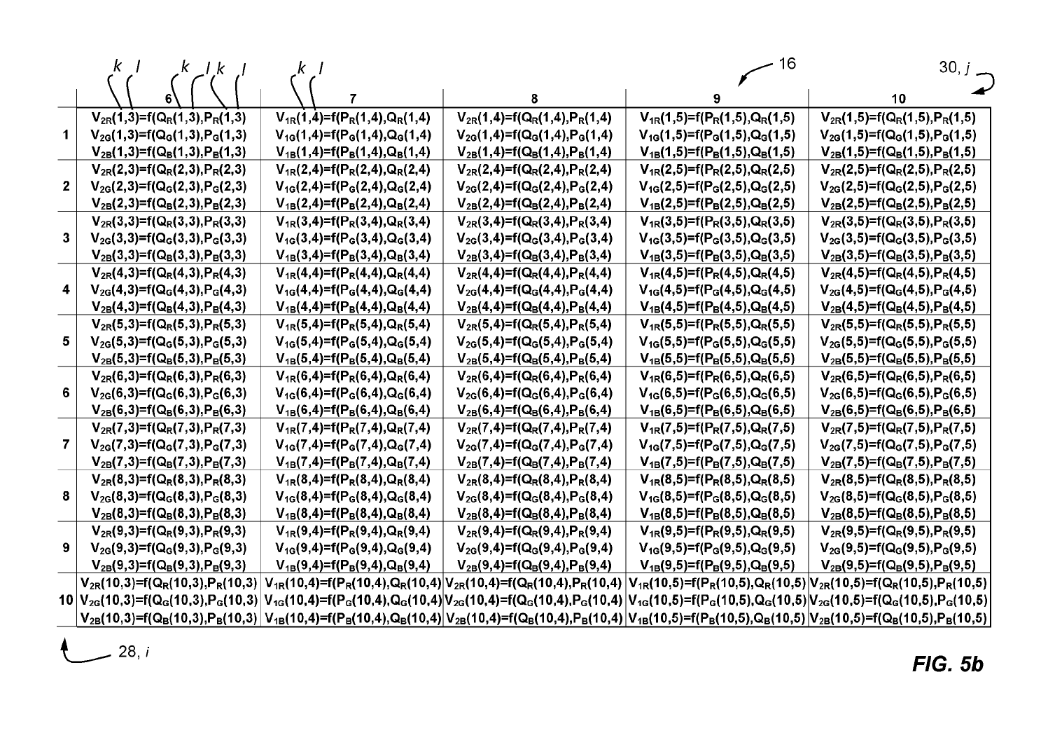

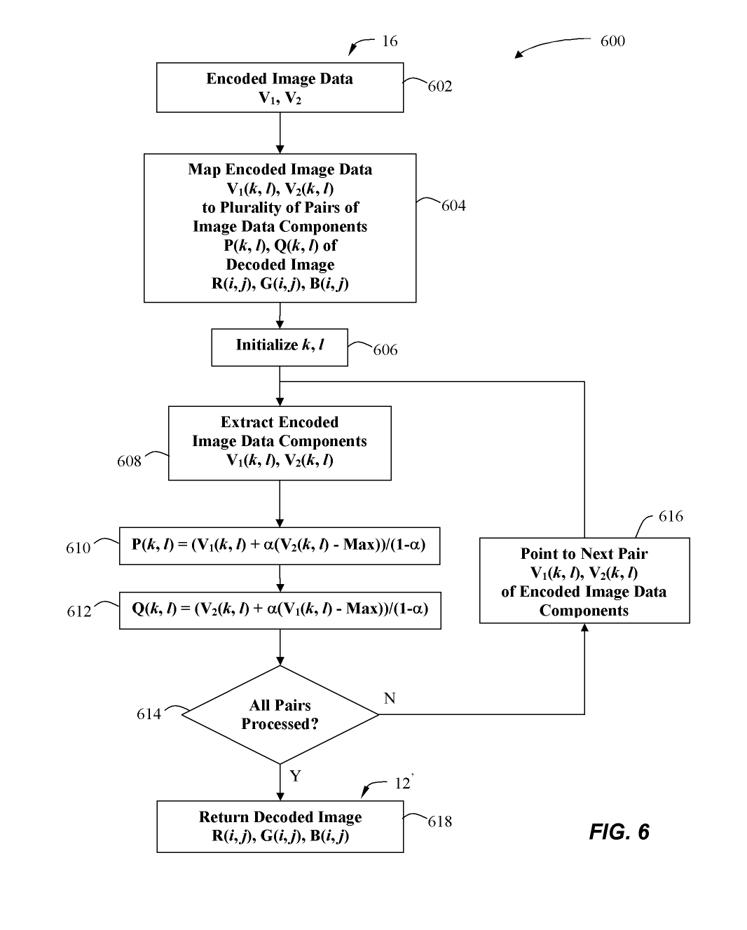

Referring to FIG. 6, an image decoding process 600 of the image decoding subsystem 18 begins in step (602) with input of the data of the encoded image 16 to be decoded. Then, in step (604), the plurality of pairs of encoded data values V₁(k, l) and V₂(k, l) in the encoded image 16 are mapped to the corresponding plurality of pairs of image data components P(k, l) and Q(k, l), for example, as described hereinabove but in reverse, wherein there is a one-to-one correspondence between image data components P(k, l) and Q(k, l) and image data components R(i, j), G(i, j), and B(i, j) of the original image 12 as described hereinabove, for example, as illustrated in FIG. 4.

Then, in step (606), the indices k, l that point to the encoded data values V₁(k, l) and V₂(k, l) are initialized, for example, to values of 0, after which, in step (608), the corresponding encoded data values V₁(k, l) and V₂(k, l) are extracted from the encoded image 16. Then, in steps (610) and (612), the corresponding pair of image data components P(k, l) and Q(k, l) are calculated as follows from the encoded data values V₁(k, l) and V₂(k, l) (assuming encoding in accordance with equations (2a) and (2b)):

P=[V₁+α·(V₂−Max)]/(1−α)=[α·(Max−V₂)−V₁]/(α−1)=f(V₁, V₂), and (3a)

Q=[V₂+α·(V₁−Max)]/(1−α)=[α·(Max−V₁)−V₂]/(α−1)=f(V₂, V₁). (3b)

Then, in step (614), if all pairs of encoded data values V₁(k, l) and V₂(k, l) have not been processed, then in step (616) the indices (k, l) are updated to point to the next pair of encoded data values V₁(k, 1) and V₂(k, l). Otherwise, from step (614), the decoded image 12′ is returned in step (618).

For example, FIGS. 7a and 7b illustrate the decoded image 12′ resulting from the encoded image 16 illustrated in FIGS. 5a and 5b, showing the relationship between the pairs of image data components P(k, l) and Q(k, l) and the corresponding encoded data values V₁(k, l) and V₂(k, l), wherein the relationship between the pairs of image data components P(k, l) and Q(k, l) and the image data components R(i, j), G(i, j), and B(i, j) of the original image 12 is that same as that illustrated in FIG. 4.

The value of α in equations (2a), (2b), (3a) and (3b) is chosen so as to balance several factors. Equations (3a) and (3b) would be unsolvable for a value of α=1, in which case equations (2a) and (2b) would not be linearly independent. Furthermore, any value approaching unity will necessarily result in increased error because of the precision of calculating P and Q is limited in any practical application, particularly using integer arithmetic. On the other hand, as the value of α becomes significantly different from unity the associated difference values will become greater and will therefore increase the variations in the data of the encoded image 16, contrary to the desired effect.

Another consideration in the selection of α is the speed at which equations (3a) and (3b) can be evaluated. Whereas the image encoding process 300 is generally not constrained to operate in real time, in many cases it is desirable that the image decoding process 600 be capable of operating in real time, so as to provide for displaying the decoded image 12′ as quickly as possible after the compressed, encoded image is received by the image decompression process 24′. With the encoded data values V₁(k, l) and V₂(k, l) in digital form, the multiplication or divisions by a power of two can be performed by left- and right-shift operations, respectively, wherein shift operations are substantially faster than corresponding multiplication or division operations. Accordingly, by choosing α so that (α−1) is a power of two, the divisions in equations (3a) and (3b) can be replaced by corresponding right-shift operations. Similarly, if α is a power of two, or a sum of powers of two, the multipications in equations (3a) and (3b) can be replaced by corresponding left-shift operations, or a combination of left-shift operations followed by an addition, respectively.

For example, for α=2, then both α=2¹ and (α−1)=1 =2° are powers of two, which provides for the following simplification of equations (3a) and (3b):

P=(V₁+2·(V₂−Max))/−1=(Max−V₂)<<1−V₁ (4a)

Q=(V₂+2·(V₁−Max))/−1=(Max−V₁)<<1−V₂ (4b)

wherein “<<n” represents an n-bit-left-shift operation, or multiplication by 2ⁿ.

Similarly, for α=3, then α=2¹+2° is a sum of powers of two, and (α−1)=2=2¹ is a power of two, which provides for the following simplification of equations (3a) and (3b):

P=(V₁+3·(V₂−Max))/−2=((Max−V₂)<<1+(Max−V₂)−V₁)>>1 (5a)

Q=(V₂+3·(V₁−Max))/−2=((Max−V₁)<<1+(Max−V₁)−V₂)>>1 (5b)

wherein “>>n” represents an n-bit-right-shift operation, or division by 2ⁿ. Whereas equations (5a) and (5b) for α=3 are relatively more complicated than equations (4a) and (4b) for α=2, α=3 may be of better use in some implementations where less error in V₁ and V₂ is desirable.

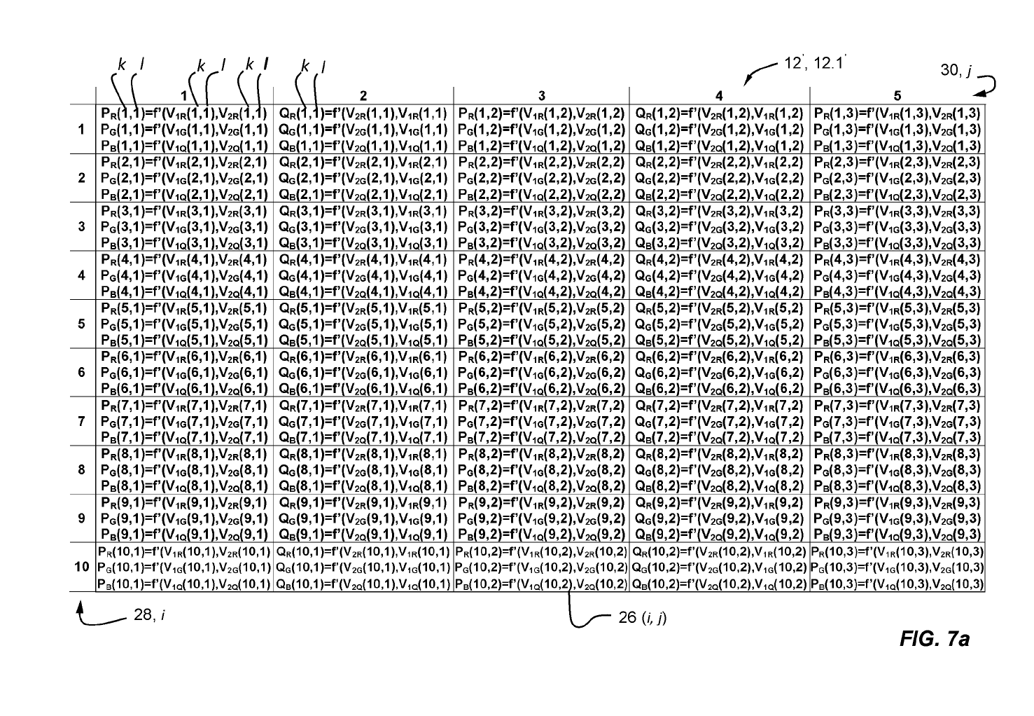

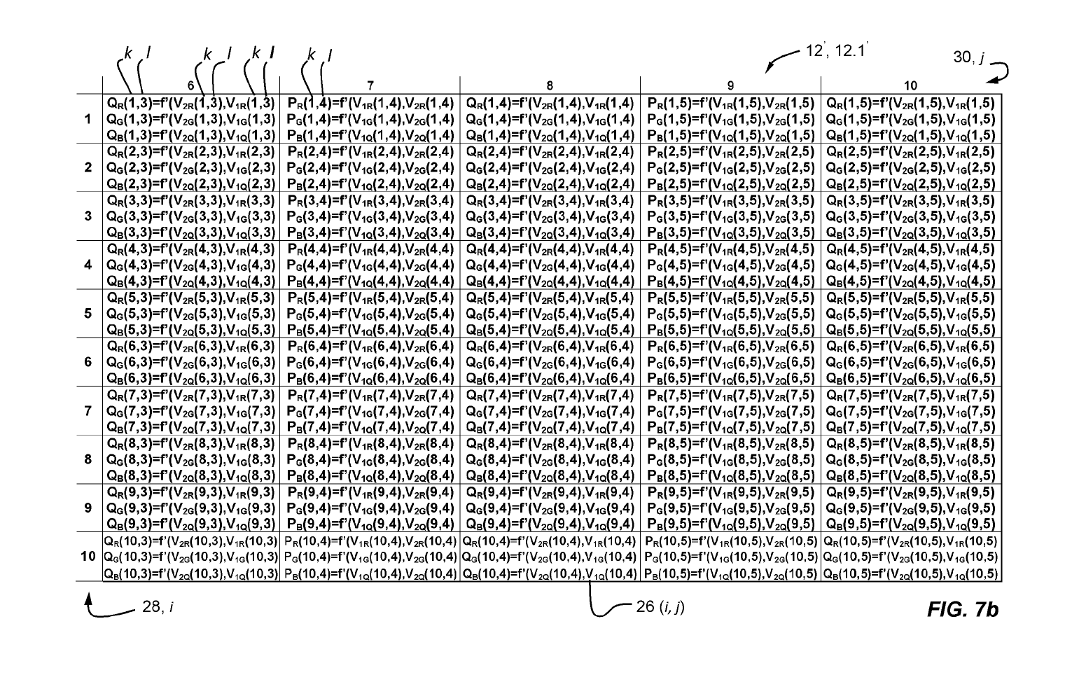

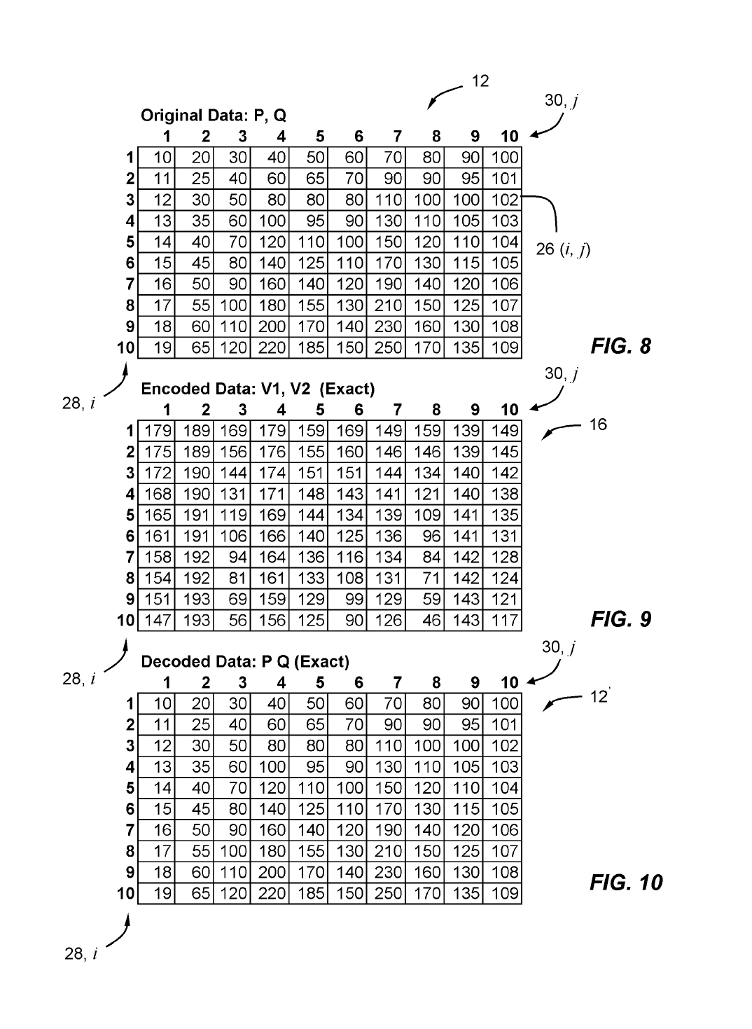

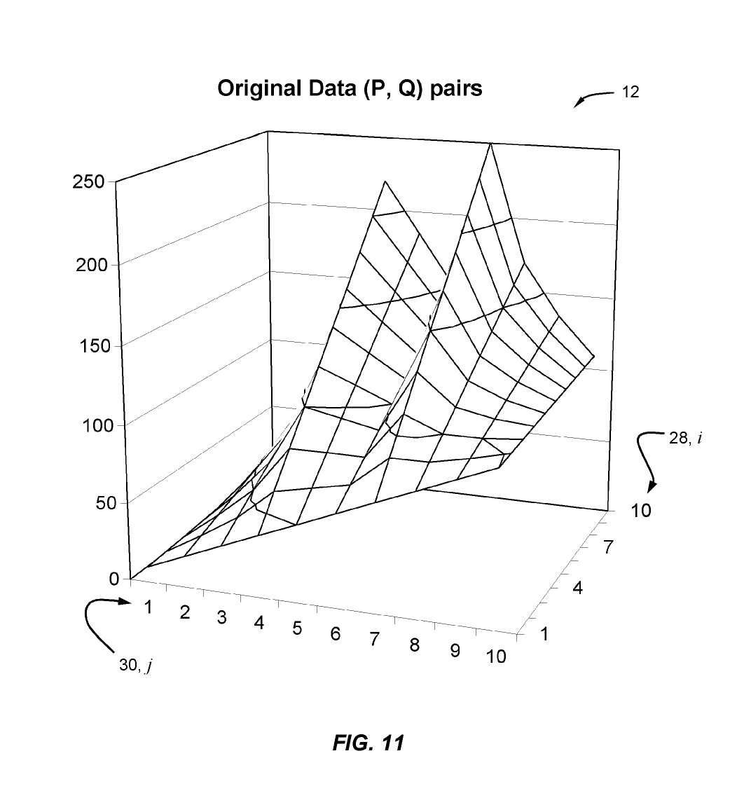

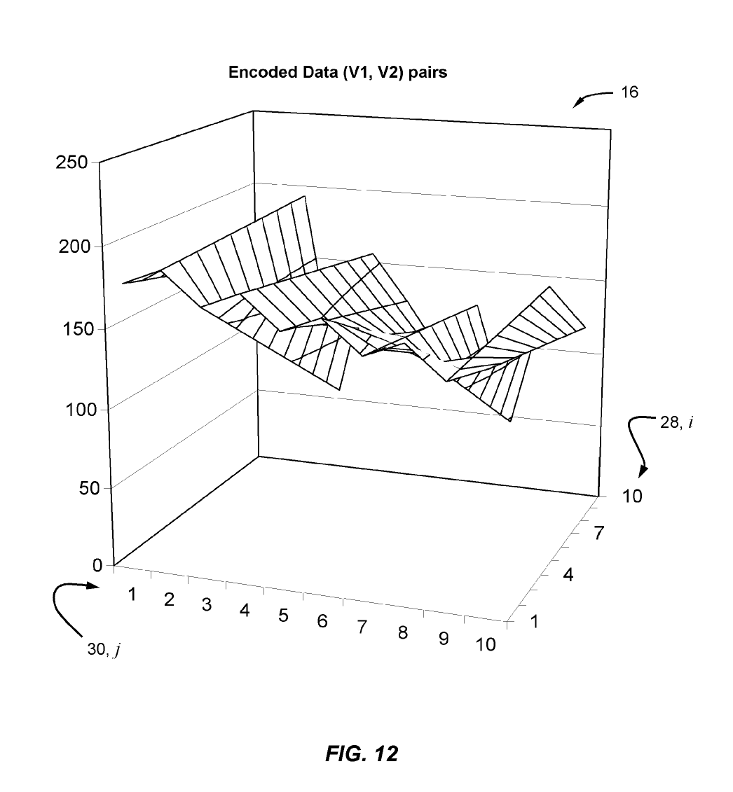

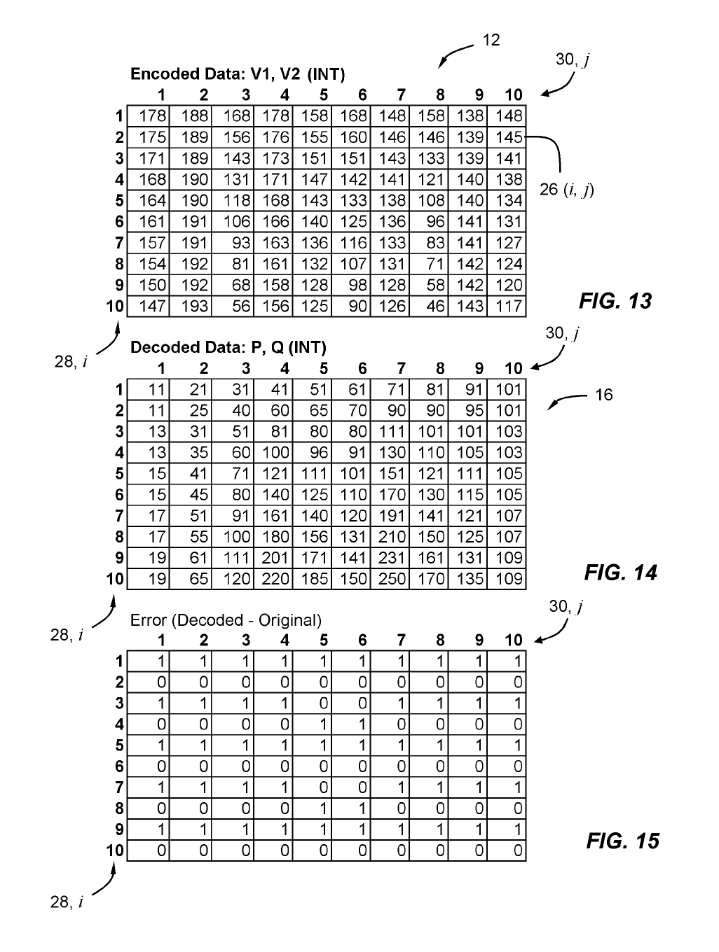

Referring to FIGS. 8-12, the action of the image encoding 10 and decoding 18 subsystems are illustrated with an exemplary set of monochromatic image data 12 that exhibits substantial variability, which is then reduced in the associated encoded image data 16. More particularly, the original monochromatic image data 12 is listed in FIG. 8 and plotted in FIG. 11. The corresponding encoded image data 16 generated therefrom with equations (3a) and (3b) with α=3 and Max=255 is listed in FIG. 9 and plotted in FIG. 12. FIG. 10 lists the corresponding decoded image data 12′, decoded in accordance with equations (4a) and (4b) from the encoded image data 16 of FIG. 9. With equations (3a) and (3b) and equations (4a) and (4b) evaluated exactly, the resulting decoded image data 12′ is the same as the original monochromatic image data 12 of FIG. 8. Referring to FIGS. 13-15, with equations (3a) and (3b) and equations (4a) and (4b) evaluated using integer arithmetic and associated integer truncation, the corresponding encoded image data 16 and decoded image data 12′ is shown in FIGS. 13 and 14, respectively, wherein the difference between the decoded image data 12′ of FIG. 14 and the original monochromatic image data 12 of FIG. 8 is listed in FIG. 15, with every other pixel being in error by one.

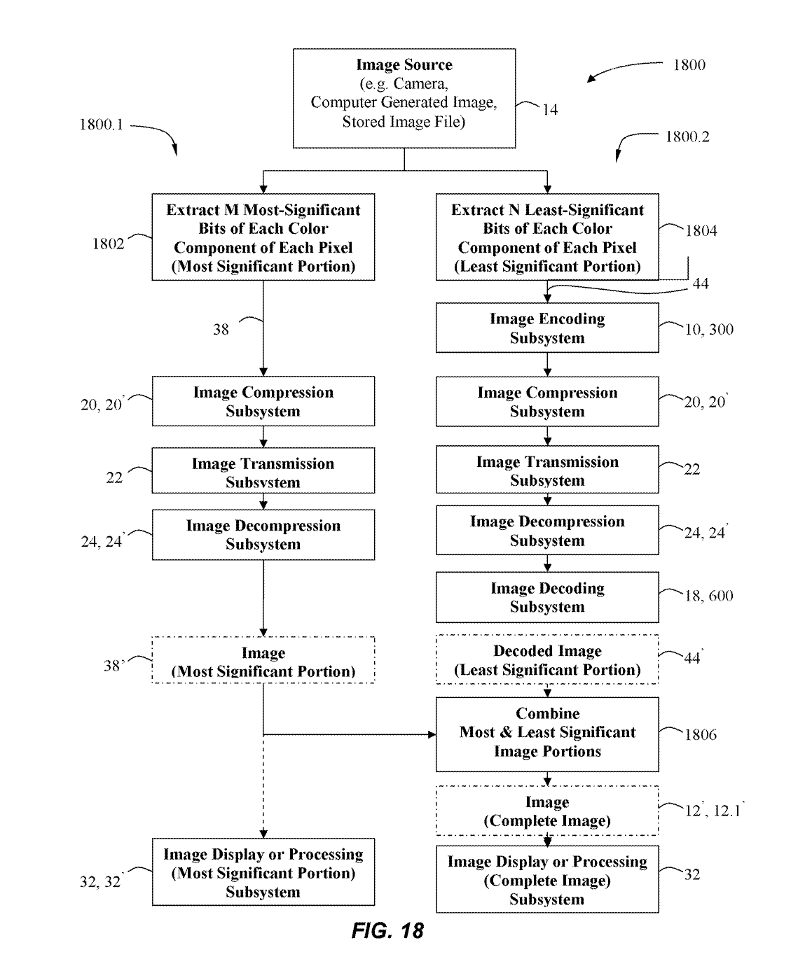

Referring to FIGS. 16-18, in accordance with a second aspect, the image encoding 10 and decoding 18 processes may be adapted to provide for encoding and decoding pixels of relatively higher precision, wherein relatively most significant (MS) and relatively least significant (LS) portions thereof are, or can be, delivered in multiple stages. For example, referring to FIG. 16, an image pixel 26 is illustrated comprising three color component R, G, B, each M+N bits in length. For example, in one embodiment, each color component R, G, B is 12 bits in length, with M=8 and N=4, with M corresponding to the most-significant (MS) portion, and N corresponding to the least-significant (LS) portion. Referring to FIG. 17a, an 3×M-bit pixel 34 comprising the most significant M bits of each color component of the 3×(M+N)-bit pixel 26 may be extracted therefrom for display on a legacy display 32′ requiring three color components R, G, B, each M bits in length, for example, 8 bits in length, and a 3×N-bit pixel 36 comprising the least-significant N bits of each color component of the 3×(M+N)-bit pixel 26 can be reserved for display in combination with the most-significant M bits on a relatively-higher-color-resolution display. In accordance with one embodiment, a 3×M-bit pixel 34 is extracted from each 3×(M+N)-bit pixel 26 of the original image 12 so as to form a reduced-color-precision image 38, that can be displayed on a legacy display 32′. In accordance with a second embodiment, the reduced-color-precision image 38 with 3×M-bit pixels 34 is transmitted for initial relatively-lower-color-precision display, and the remaining 3×N-bit pixels 36 are transmitted separately with encoding and decoding so as to provide for forming and subsequently displaying a full-color-precision decoded image 12′. More particularly, referring to FIG. 18, a first portion 1800.1 of a second aspect of an image processing system 1800, in step (1802), provides for extracting and processing a most-significant portion MS, 40 of each pixel 26 of a relatively-high-color-precision image 12, 12.1 as a 3×M-bit pixel 34 comprising the most significant M bits of each color component the 3×(M+N)-bit pixel 26, so as to form a corresponding reduced-color-precision image 38 that, in one embodiment, is subsequently conventionally compressed, transmitted and decompressed by respective image compression 20, image transmission 22 and image decompression 24 subsystems, so as to transmit a copy of the reduced-color-precision image 38′ to a second location. Alternatively, the first portion 1800.1 of a second aspect of an image processing system 1800 could also provide for encoding the reduced-color-precision image 38 prior to compression, and decoding the corresponding resulting decompressed encoded image following decompression, as described hereinabove for the first aspect of the image processing system 100, but with respect to only the most-significant portion MS, 40 of the original image 12.

A second portion 1800.2 of a second aspect of an image processing system 1800, in step (1804), provides for extracting and processing a least-significant portion LS, 42 of each pixel 26 of a relatively-high-color-precision image 12, 12.1 as a 3×N-bit pixel 36 comprising the least significant N bits of each color component the 3×(M+N)-bit pixel 26, so as to form a corresponding supplemental image 44 that, as described hereinabove for the is encoded by the first aspect of the image processing system 100, is then encoded by the image encoding subsystem 10 in accordance with the image encoding process 300, then compressed by the image compression subsystem 20, transmitted by the image transmission subsystem 22, decompressed by the image decompression subsystem 24, and then decoded by the image decoding subsystem 18 in accordance with the image decoding process 600, so as to generate a corresponding decoded supplemental image 44′ comprising an array of 3×N-bit pixels 36 each containing the least-significant portion LS, 42 of a corresponding pixel 26 of the associated relatively-high-color-precision image 12, 12.1.

Then, in step (1806), each pixel 26 of the relatively-high-color-precision image 12, 12.1 is reconstructed by combining the most-significant portion 40 from the reduced-color-precision image 38′ from the first portion 1800.1 of the image processing system 1800 with the least-significant portion 42 from the decoded supplemental image 44′ so as to generate the a corresponding decoded relatively-high-color-precision image 12′, 12.1′.

It should be understood that that first 1800.1 and second 1800.2 portions of the image processing system 1800 can operate either sequentially or in parallel. For example, when operated sequentially, the reduced-color-precision image 38′ might be displayed first relatively quickly, followed by a display of the complete decoded relatively-high-color-precision image 12′, 12.1′, for example, so as to accommodate limitations in the data transmission rate capacity of the image transmission subsystem 22.

The second aspect of the image processing system 1800 provides for operating in a mixed environment comprising both legacy video applications for which 8-bit color has been standardized, and next-generation video applications that support higher precision color, for example 12-bit color. For example, the first 8-bit image could employ one conventional channel and the second 4-bit image could employ a second channel, for example, using 4 bits out of 8 bits of a conventional 8-bit channel. Furthermore, the second could be adapted to accommodate more than 4 bits of additional color precision, or the remaining 4 bits of such a second channel may be applied to the encoding, transmission, storage and/or decoding of other image information, including, but not limited to, additional pixel values supporting increased image resolution.

Generally, the image processing system and method described herein provides for encoding an image by replacing a subset of original pixel data components with a corresponding set of encoded values. For each subset, there is a one-to-one correspondence between the original pixel data components and the corresponding encoded values, each encoded value is determined from a linear combination of the original pixel data components of the subset responsive to generalized differences between the original pixel data components, and the encoded values are linearly independent of one other with respect to the original pixel data components. A corresponding decoding process operates by inverting the decoding process, so as to provide for recovering the original pixel data components with substantial accuracy. Although the examples of subsets have been illustrated comprising pairs of original pixel data components and corresponding pairs of encoded values, the number of elements in each subset is not necessarily limited to two.

While specific embodiments have been described in detail in the foregoing detailed description and illustrated in the accompanying drawings, those with ordinary skill in the art will appreciate that various modifications and alternatives to those details could be developed in light of the overall teachings of the disclosure. It should be understood, that any reference herein to the term “or” is intended to mean an “inclusive or” or what is also known as a “logical OR”, wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C),

(B, C), and (A, B, C); and so on if additional elements are listed. Furthermore, it should also be understood that the indefinite articles “a” or “an”, and the corresponding associated definite articles “the” or “said”, are each intended to mean one or more unless otherwise stated, implied, or physically impossible. Yet further, it should be understood that the expressions “at least one of A and B, etc.”, “at least one of A or B, etc.”, “selected from A and B, etc.” and “selected from A or B, etc.” are each intended to mean either any recited element individually or any combination of two or more elements, for example, any of the elements from the group consisting of “A”, “B”, and “A AND B together”, etc. Yet further, it should be understood that the expressions “one of A and B, etc.” and “one of A or B, etc.” are each intended to mean any of the recited elements individually alone, for example, either A alone or B alone, etc., but not A AND B together. Furthermore, it should also be understood that unless indicated otherwise or unless physically impossible, that the above-described embodiments and aspects can be used in combination with one another and are not mutually exclusive. Accordingly, the particular arrangements disclosed are meant to be illustrative only and not limiting as to the scope of the invention, which is to be given the full breadth of the appended claims, and any and all equivalents thereof

What is claimed is:

1. A method of encoding a digitized image, comprising:
a. selecting at least a portion of a pair of correlated image data components of a digitized image, wherein said pair of correlated image data components comprises first and second image data components;
b. determining a first encoded value proportional to a first difference between said first image data component and a first product, wherein said first product comprises said second image data component multiplied by a first factor;
c. determining a second encoded value proportional to a second difference between said second image data component and a second product, wherein said second product comprises said first image data component multiplied by said first factor;
d. forming a corresponding pair of encoded image data components of a corresponding encoded digitized image from said first and second encoded values; and
e. repeating steps a through d for each of a plurality of pairs of correlated image data components of said digitized image, so as to generate said corresponding encoded digitized image.

2. A method of encoding a digitized image as recited in claim 1, wherein said first and second image data components are representative of a like color for different laterally-adjacent pixels or different diagonally-adjacent pixels.

3. A method of encoding a digitized image as recited in claim 1, wherein said first and second image data components are representative of different colors for a same pixel.

4. A method of encoding a digitized image as recited in claim 1, wherein said first and second image data components contain corresponding least-significant portions of corresponding image pixel data.

5. A method of encoding a digitized image as recited in claim 1, wherein said first product further comprises an offset value multiplied by said first factor, and said second product further comprises said offset value multiplied by said first factor.

6. A method of encoding a digitized image as recited in claim 1, wherein said first factor is equal to either a power of two or a sum of powers of two.

7. A method of encoding a digitized image as recited in claim 1, wherein said first encoded value is further responsive to, or is mathematically equivalent to, division of said first difference by a second factor, and said second encoded value is further responsive to, or is mathematically equivalent to, division of said second difference by said second factor.

8. A method of encoding a digitized image as recited in claim 7, wherein a magnitude of said second factor differs from a magnitude of said first factor by a value of one.

9. A method of encoding a digitized image as recited in claim 1, wherein the operation of forming said corresponding pair of encoded image data components of said corresponding encoded digitized image from said first and second encoded values comprises:
a. replacing said first image data component with said first encoded value; and
b. replacing said second image data component with said second encoded value.

10. A method of encoding a digitized image as recited in claim 1, further comprising compressing said corresponding encoded digitized image so as to generate a corresponding compressed encoded digitized image for transmission to a separate location.

11. A method of encoding a digitized image as recited in claim 10, further comprising transmitting said corresponding compressed encoded digitized image to said separate location.

12. A method of decoding a digitized image, comprising:
a. receiving a pair of first and second encoded data values associated with a corresponding portion of a corresponding digitized image;
b. generating a corresponding pair of first and second image data components from said pair of first and second encoded data values, wherein said first image data component is proportional to a first sum of said first encoded data value and a first product, said first product comprises said second encoded data value multiplied by a first factor, said second image data component is proportional to a second sum of said second encoded data value and a second product, and said second product comprises said first encoded data value multiplied by said first factor;
c. forming said corresponding portion of said corresponding digitized image from said corresponding pair of first and second image data components; and
d. repeating steps a through c for each of a plurality of pairs of first and second encoded data values so as to generate said corresponding digitized image.

13. A method of decoding a digitized image as recited in claim 12, wherein said corresponding pair of first and second image data components are representative of a like color for different laterally-adjacent pixels or different diagonally-adjacent pixels.

14. A method of decoding a digitized image as recited in claim 12, wherein said corresponding pair of first and second image data components are representative of different colors for a same pixel.

15. A method of decoding a digitized image as recited in claim 12, wherein said corresponding pair of first and second image data components contain corresponding least-significant portions of corresponding image pixel data.

16. A method of decoding a digitized image as recited in claim 12, wherein said first factor is equal to either a power of two or a sum of powers of two.

17. A method of decoding a digitized image as recited in claim 12, wherein said first image data component is further responsive to, or is mathematically equivalent to, division of said first sum by a second factor, and said second image data component is further responsive to, or is mathematically equivalent to, division of said second sum by said second factor.

18. A method of decoding a digitized image as recited in claim 17, wherein a magnitude of said second factor differs from a magnitude of said first factor by a value of one.

19. A method of decoding a digitized image as recited in claim 12, wherein the operation of forming said corresponding portion of said corresponding digitized image from said corresponding pair of first and second image data components comprises:
a. replacing said first encoded data value with said first image data component; and
b. replacing said second encoded data value with said second image data component.

20. A method of decoding a digitized image as recited in claim 12, wherein the operation of receiving said pair of first and second encoded data values comprises:
a. receiving a compressed-digitized-encoded image;
b. decompressing said compressed-digitized-encoded image so as to generate a corresponding resulting set of decompressed image data; and
c. extracting said pair of first and second encoded data values from said corresponding resulting set of decompressed image data.

21. A method of providing for decoding a digitized image, comprising:
a. providing for receiving a pair of first and second encoded data values associated with a corresponding portion of a corresponding digitized image;
b. providing for generating a corresponding pair of first and second image data components from said pair of first and second encoded data values, wherein said first image data component is proportional to a first sum of said first encoded data value and a first product, said first product comprises said second encoded data value multiplied by a first factor, said second image data component is proportional to a second sum of said second encoded data value and a second product, and said second product comprises said first encoded data value multiplied by said first factor;
c. providing for forming said corresponding portion of said corresponding digitized image from said corresponding pair of first and second image data components; and
d. providing for repeating steps a through c for each of a plurality of pairs of first and second encoded data values so as to generate said corresponding digitized image.
